(19) United States
(12) Patent Application Publication
(10) Pub. No.: US 2003/0088441 A1
(43) Pub. Date: May 8, 2003

(54) System for the integrated management of healthcare information

(76) Inventor: Michelle McNerney, Freehold, NJ (US)

Correspondence Address: DICKSTEIN SHAPIRO MORIN & OSHINSKY LLP, 1177 AVENUE OF THE AMERICAS, NEW YORK, NY, 10038-2714, US

(21) Appl. No.: 10/008,021

(22) Filed: Nov. 8, 2001

(51) Int. Cl. G06F 17/60

(52) U.S. Cl. 705/3

(57) ABSTRACT

The MD Net Exchange system creates an integrated solution for the healthcare industry, integrating modular applications, networks and data exchanges that interconnect physicians, patients, hospitals, insurance companies and other parties involved in healthcare. The invention provides a secure network and server system that allows each party to input, update and share information, and access it from any location connected to the network.

### FIELD OF THE INVENTION

This invention generally relates to computerized decision-support, data management and patient identification systems for the healthcare industry and more particularly to an automated health care system that provides numerous advantages for the patient, the doctor, the hospital and the insurance provider.

### BACKGROUND OF THE INVENTION

The U.S. healthcare industry, in comparison to other industries, has lagged behind in the creative use of technology, particularly in the area of data management due to cost, security and patient privacy concerns. The industry as a whole has not made significant investments of its revenue into technology aimed at streamlining its operations. However, recent cost cutting pressures have made it necessary for the industry to look closely at technological solutions to improve its efficiency.

By switching from a traditional paper-based information system to an electronic system powered by Internet technology, the healthcare industry can quickly realize dramatic cost savings. Electronic prescription filing, automated insurance claims, computerized medical records, and standardized patient IDs can ensure compliance with regulations, save valuable time and eliminate human errors. These electronic solutions can help recover money wasted on inefficient and repetitive processes, as well as reduce cases of medical errors and malpractice.

It is well known that the primarily paper-based information systems widely in use today lack the ability to promptly retrieve medical records, leading to delay and unnecessary expense. Other shortcomings include but are not limited to: ease of forging a patient's identity for the purposes of claims and benefits fraud; patient identification cards supplying only limited information; difficulties in deciphering illegible handwriting and spelling errors in hand-written prescriptions; misfiled documents and human errors leading to increased malpractice insurance rates; time-consuming insurance claim forms that are overly complicated; doctors having to constantly keep up-to-date on new drugs coming to market; burdensome check-in processes at hospitals; and difficulties in complying with complicated insurance procedures.

Recently several companies have started Internet websites to provide health care advice, share medical news, fill prescriptions and sell pharmaceutical supplies and drugs at discounted prices. These include Healthon/WebMD (www.webmd.com) and www.Drkoop.com. However, none of these companies provide a complete hardware/software solution which benefits all aspects of the healthcare system, and which is coupled with user-friendly access for the patient who may not be computer savvy, or may not have access to the Internet.

It is therefore an object of the present invention to provide a user-friendly system which creates an integrated solution for data management in the healthcare industry.

It is a further object of the present invention to provide a secure network and sever system that allows healthcare practitioners to integrate information from multiple sources and to readily access that information from a plurality of locations.

### SUMMARY OF THE INVENTION

To address the shortcomings in the handling of information in the healthcare industry, the present invention provides an integrated, modular solution to the industry's information management needs. The central module is a secure database called the Patient Medical Information System (“PMIS”). All other modules/applications, including modules for patient registration, generation and verification of patient identification cards, collection of patient medical history, examination and diagnosis of patients, generation of reports and lab tests, filing of prescriptions, filing of insurance claims, etc., deposit, retrieve and update data from the PMIS.

It is a feature of the invention that data, modified by any one of the modular applications, is instantly available to different users in the industry, eliminating any redundancy and greatly reducing the cost of processing and maintaining this information.

It is a further feature of the invention that by centralizing a patient's medical history, the invention can assist the physician by providing automated decision-support services in the physician's choice of treatment options and preparation of medical reports.

It is still a further feature of the invention that a patient is allowed to access and to update his or her information, even if the patient is not computer-savvy or does not have access to the Internet.

These and other objects and features of the invention will be more fully appreciated from the following detailed description when taken in conjunction with the accompanying drawings.

### BRIEF DESCRIPTION OF DRAWINGS

FIG. 1. shows the universe of MD Net Exchange users, each with different information demands.

FIG. 2. shows the system architecture of the MD Net Exchange and the PMIS database in a Business to Business model.

FIG. 3. shows the system architecture of the MD Net Exchange and the PMIS in a Centric model.

FIG. 4. shows a sample flow of data to and from the PMIS database, and between different users/modules.

FIG. 5. shows a sample of tables used in the Universal Medical Graphic User Interface (“UM-GUI”) forms.

FIG. 6. shows a sample UM-GUI Patient information form.

FIG. 6a-6k show sample Interactive UM-GUI information forms.

FIG. 7. shows a sample UM-GUI Patient medical history form.

FIG. 8. is a representation of the Easy Patient Registration (“EZ-R”) Kiosk.

FIG. 9. is a representation of the EZ-R Kiosks with a privacy screen.

FIG. 10. is a flowchart showing the operation of the EZ-MD card.

FIG. 11 shows a sample Physician Examination Module scheduling screen.

FIG. 12 shows a sample Physician Examination Module medical report screen.

FIG. 13. shows a sample initial drug selection screen of the Electronic Prescription Module.

FIG. 14. shows a sample Drug Reference screen of the Electronic Prescription Module.

### DESCRIPTION OF PREFERRED EMBODIMENT

In the preferred embodiment of the invention, the “MD Net Exchange” is an integrated, modular hardware and software system consisting of a central patient medical information database (the PMIS) and customizable application modules (“MD Net Exchange Modules”) that cater to the different needs of different healthcare providers and patients.

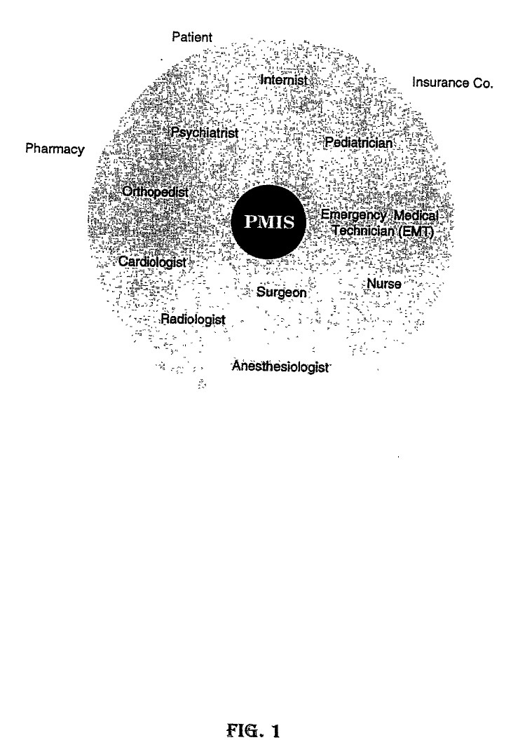

Referring to FIG. 1, the PMIS is designed to provide a secure, convenient, cost-effective and timely means to store and exchange medical information for doctors, specialists, patients, administrators, insurance companies, pharmacies, and laboratories. The goal of the PMIS is to reduce and even eliminate the need for paper forms. Data and images from medical records, x-rays, prescriptions, lab reports, insurance forms can be uploaded, stored and shared by the different parties. The PMIS would have the following characteristics: Convenient—Data can be retrieved from anywhere at any time via the Internet, preferably with standard Internet browsers such as Microsoft Internet Explorer or Netscape Navigator; Fast—Information can be made available and also updated almost instantaneously; Customizable—The database architecture will be able to handle any form or chart including patient's medical history information forms, hospital admission forms, laboratory test forms, surgeon's forms, and many specialist's forms depending on the needs of the healthcare provider; Cross-referenced—Information stored in one form would be cross-referenced to the same information stored on another form to ensure updated and accurate information; Private—Personal and sensitive data can only be accessed by authorized parties; Secure—Encryption and Firewall technologies are employed to shield unauthorized access during data transmission and storage; Safe Data is transmitted over reliable connections such as a Virtual Private Network (VPN) and backed up on timely basis to avoid loss; Critical—the database is an invaluable tool for medical services in emergency situations; Accurate—the database would eliminate human errors present in conventional ways of entering information.

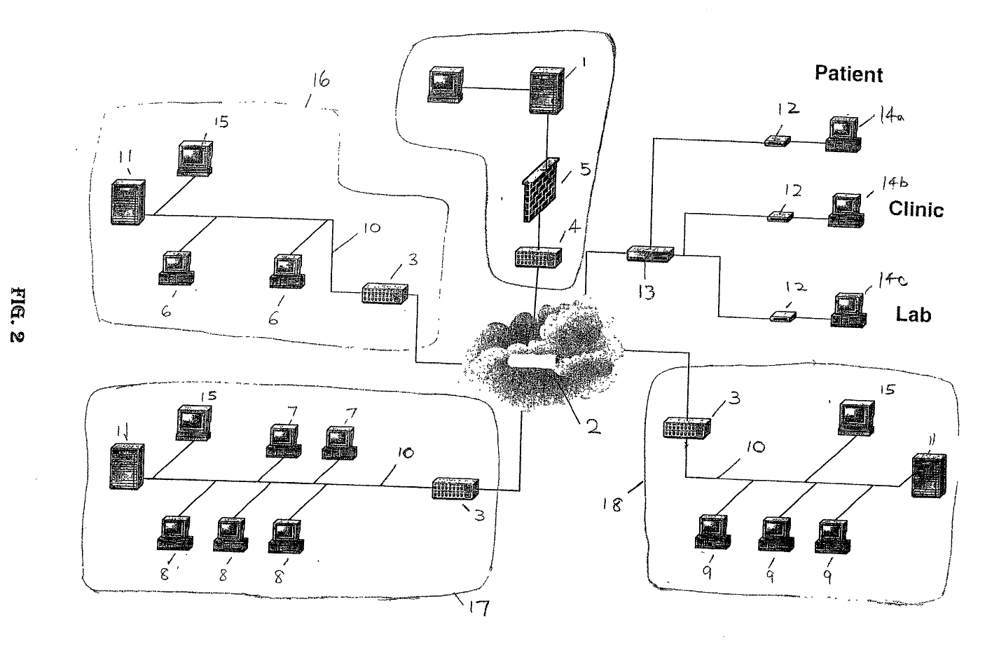

In one embodiment of the MD Net Exchange as depicted in FIG. 2, the PMIS database would reside on a central computer server 1 accessible through a shared network 2 such as the Internet. Any number of healthcare providers, for example, a pharmacy 16, a hospital 17 and an Insurance company 18, with their own private networks 10, can set up users stations for pharmacists 6, doctors 7, patients 8, and Claim Specialists 9 to input and to retrieve information from local servers 11. These local servers 11 with any necessary administrator stations 15 would run specialized modular database applications (“MD Net Exchange Modules”) which can handle the different information needs of the different users. Business to Business (“B2B”) servers 3 at the healthcare providers networks would synchronize the information between the Modules and the PMIS through the B2B server 4 of MD Net Exchange, the PMIS database being secured behind a firewall 5. Users with PCs not connected to a network, for example, a patient 14a, a clinic 14b, and a laboratory 14c, can access the PMIS through the use of modems 12 connected to their PCs which can access the central server 1 through an Internet Service Provider (“ISP”) 13.

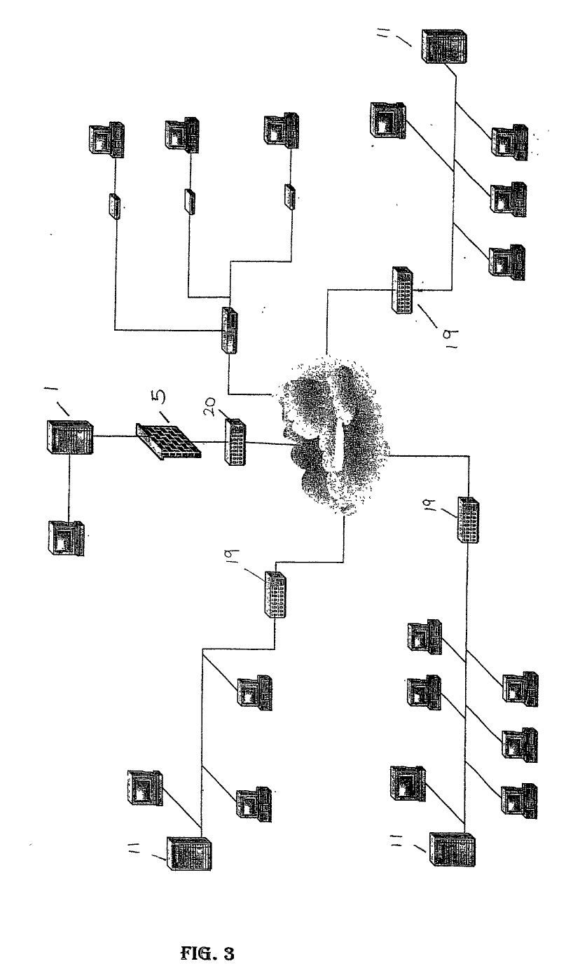

Alternatively, in the embodiment depicted in FIG. 3, the MD Net Exchange Modules and the PMIS would both reside in the centralized server 1, and the users would access their specialized modules through the use of Virtual Private Network (VPN) Gateways 19 create a secure connection to MD Net Exchange's VPN Gateway 20 and the central server 1. It is to be understood that the embodiments are not mutually exclusive and the invention can have modules that are centralized and modules that are distributed. Each module may, in fact, have sub-components that reside on different servers.

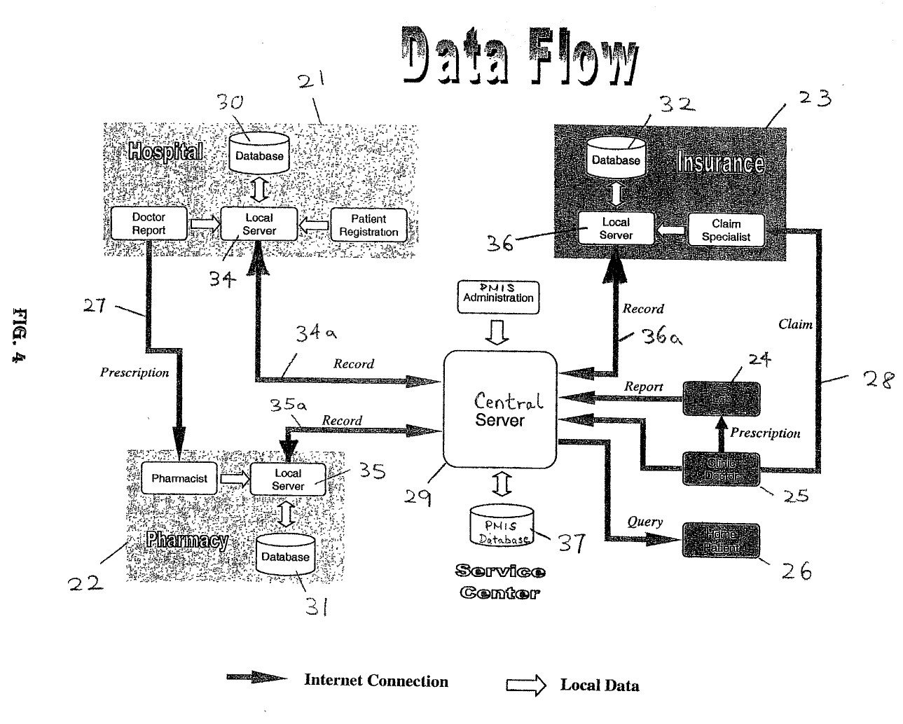

FIG. 4 shows the data flow between the users (which, as in the examples above, show a hospital 21, a pharmacy 22, an insurance company 23, a laboratory 24, a clinic 25 and a patient 26). By making use of secure Internet connections, data can freely flow between users/modules, and between modules and the PMIS database. Data flow that requires action on the part of the recipient, such as when a doctor files a prescription electronically 27, or when an administrator at a doctor's office files an insurance claim form with a claim specialist at the insurance company 28, can bypass the Central Server 29 and communicate between the users/Modules directly. Local databases, in this example the Hospital database 30, Pharmacy database 31 and Insurance Company database 32, kept on local servers 34, 35, 36, will access the Central Server (arrows 34a, 35a, 36a) to synchronize the patient information with the PMIS database 37.

In order to facilitate and standardize this flow of data from many different parties, and to ensure that each patient's information is always kept up-to-date, the invention creates and makes use of Universal Medical-Graphical User Interface (UM-GUI) forms to replace the paper medical forms in use today. UM-GUI forms can be created as standard HTML forms that can be read and filled out through the use of a standard Internet browser program such as Microsoft® Internet Explorer or Netscape® Navigator. Alternatively, the UM-GUI forms can be created as JAVA applets which can incorporate levels of interactivity in assisting the user in filling out the forms. In eliminating the need for the hundreds of different paper forms in use today, UM-GUI simplifies the process by re-organizing and revising the form content targeted for each different medical provider. For example, there will be forms for primary care physicians, medical specialists, hospitals and labs. Forms can be further customized for each user's requirements. Furthermore, UM-GUI can support all major insurance companies' claim forms by allowing many options and furnishing an inclusive database system.

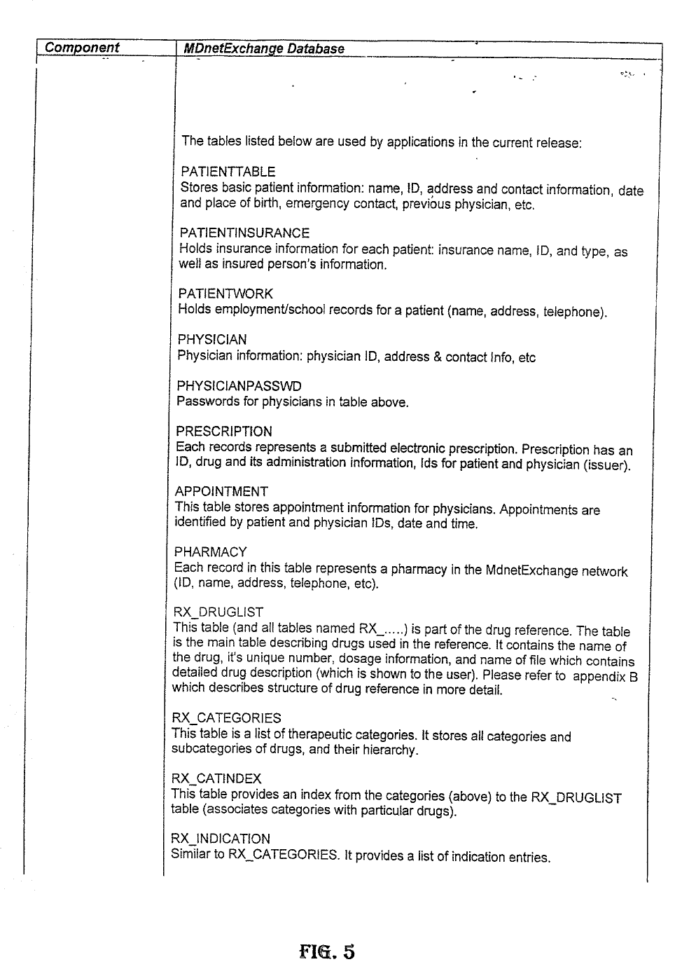

The UM-GUI forms can accommodate all pertinent information about a patient's history. The information will be entered and stored in uniquely identified tables, with names that are uniform across all users and modules. This ensures that information on each patient entered by different users will not be duplicated, and that updated information is always synchronized with all users. FIG. 5 shows a sample of the tables that make up each patient's record in the PMIS database. A patient's personal information, his physician's information, procedures performed, medicines prescribed, tests performed, and family medical histories will all be consolidated into a patient's record in the PMIS. Each patient's record can grow into a virtual patient medical information encyclopedia, which will be available to the patient and all necessary medical providers. Specifically, the comprehensive patient's medical history can be presented with multimedia technologies which include voice, images, audio and video. For example, if a doctor needs to review a prior CAT scan done on the patient, he can retrieve it directly from the database, even if the test was done at a different facility or ordered by a different physician, and the doctor can view the scan directly on his computer.

The Patient Easy Registration module (“EZ-R Module”) is one of the MD Net Exchange Modules. The EZ-R module offers an easier way for hospitals and doctor's offices to deal with medical records. One of the primary inefficiencies in Healthcare Information Management is that patient information frequently has to be re-entered every time the customer visits a physician, the hospital, or any specialist. The EZ-R Module eliminates the need for administrators to re-enter the information by interactively guiding the patient to fill out an UM-GUI form. Once the patient has registered with the system, the EZ-R module can easily verify the patient's identity easily by using biometrics identification technologies.

The EZ-R Module consists of two components: The Smart Card patient identification system (“EZ-MD card”) and the automated patient registration kiosk system (“EZ-R Kiosks”). The two components use Smart Card and biometrics identification technologies in conjunction to securely control access to the patient's medical records, and to accurately verify the patient's identity. For administrative and emergency purposes, the EZ-MD card can also store (and keep updated) a patient's vital information on the card's microprocessor chip. The Automated EZ-R Kiosks, to be placed in hospitals, doctors' offices and pharmacies, allow patients to easily verify their identities, and to input and update the information on their EZ-MD Card without the need for the patients to be computer-savvy or have access to the Internet. Alternatively, patients with access to the Internet can choose to register and/or update their information using a Internet browser program accessing the MD Net Exchange server through a secure connection.

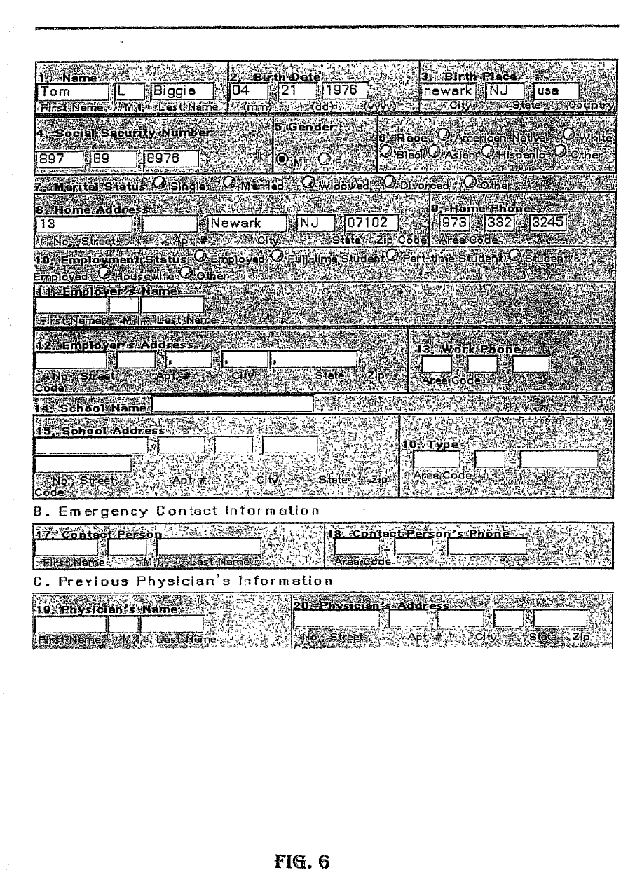

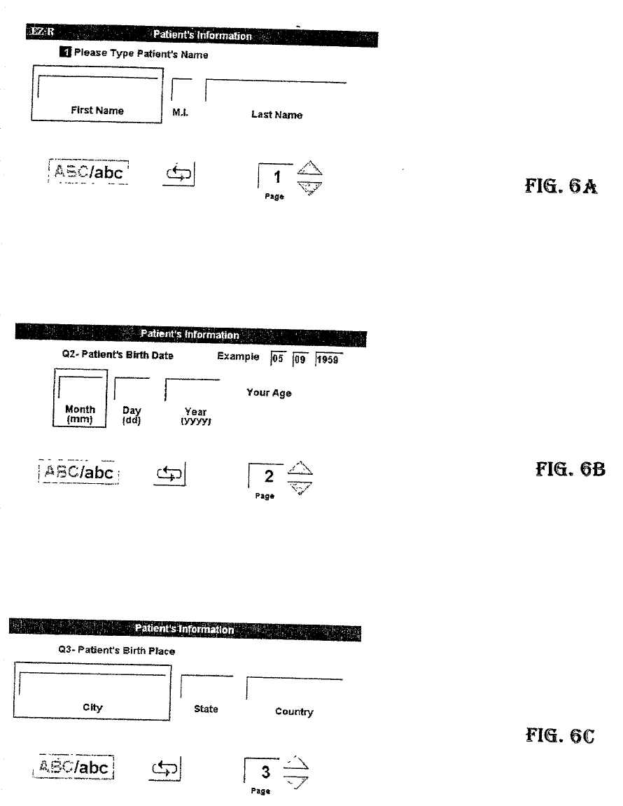

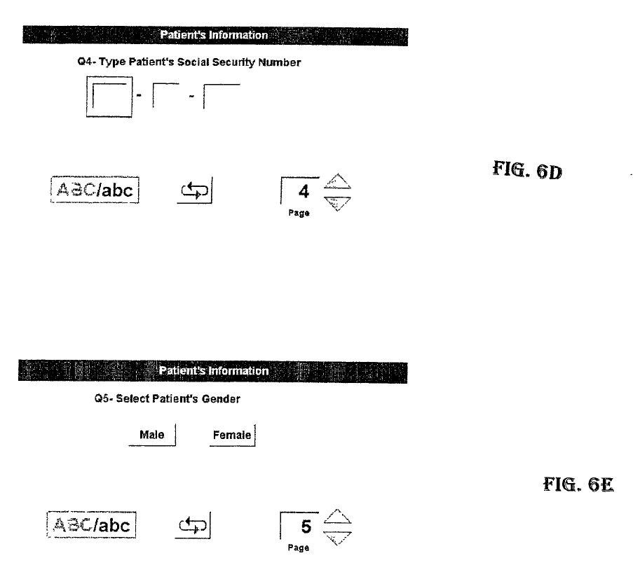

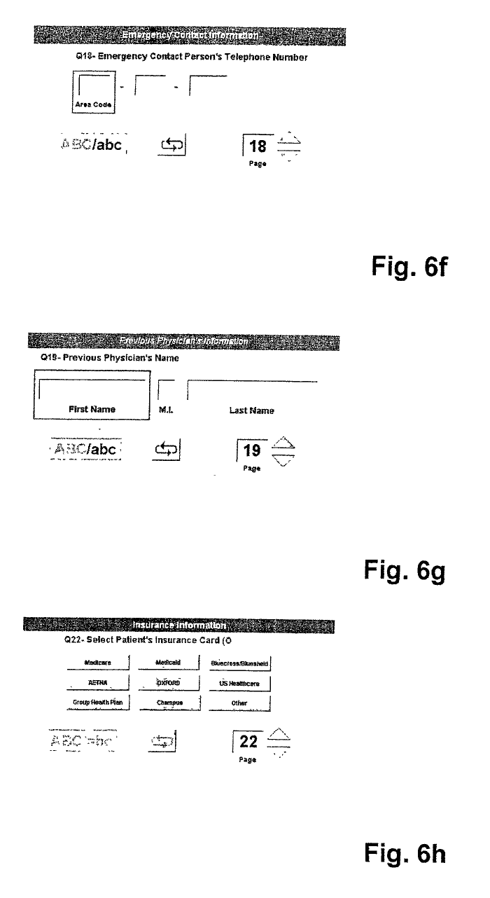

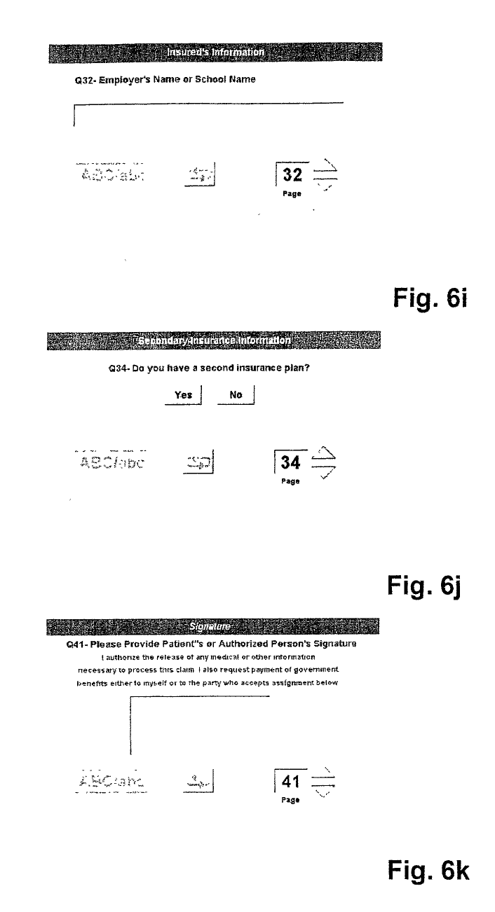

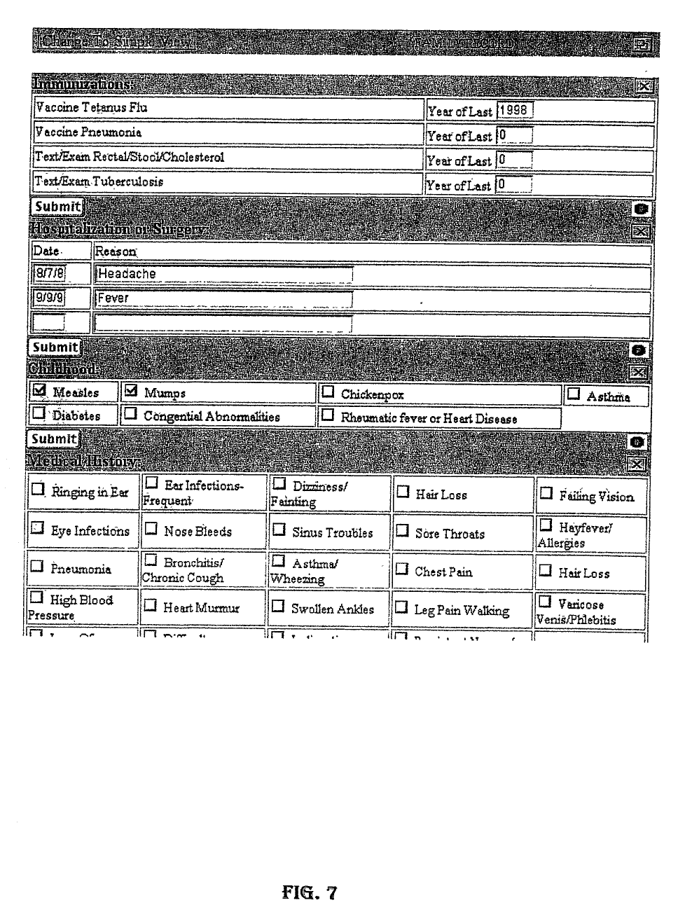

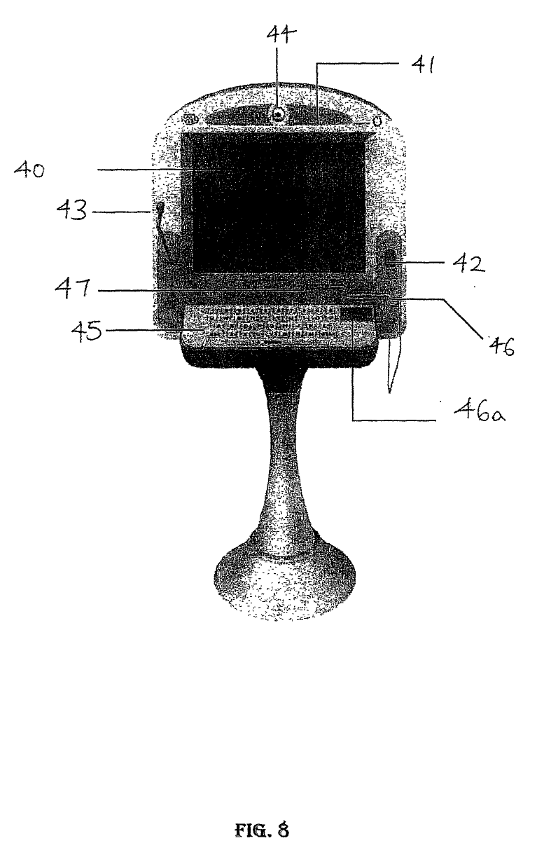

The patient will need to enter his or her basic information only once at an EZ-R Kiosk during the initial registration. FIG. 6 shows a sample UM-GUI personal information form and FIG. 7 shows a sample UM-GUI medical history form that the patient will be asked to fill out. The layout of these forms will be kept simple and will make extensive use of pull down menus and checkboxes to simplify filling out the form. Alternatively, in another embodiment represented by FIGS. 6a-6k, the UM-GUI forms can be incorporated with Interactive features that could limit a patient's response to one question on the screen at one time, with the possible responses being context-sensitive. Ready-made response buttons such as “male” or “female”, or the names of the accepted insurance plans, can be incorporated (See e.g., FIGS. 6e, 6h). Further, Artificial Intelligence routines can be built-into the application module so that branching, context-sensitive sets of questions will appear depending on the patient's response. For example, if the patient replied in the positive to a question on whether there is a family history of heart disease, additional questions on his diet and exercise habits may follow.

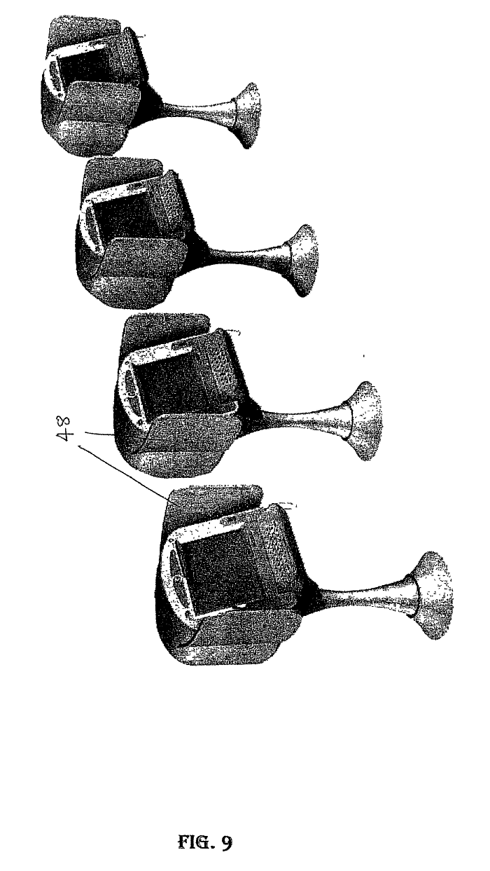

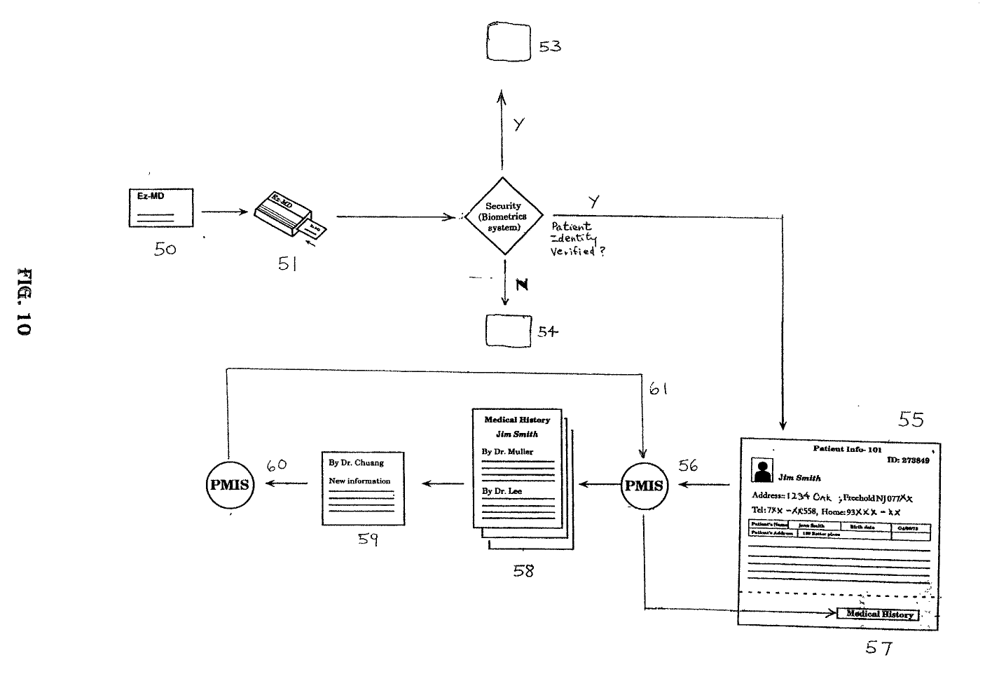

The EZ-R Kiosk is built with interactive features and ease of use as one of its goals, so that any patient can easily access it. Referring to FIG. 8, the EZ-R Kiosk is a computer terminal which is connected to a Local Area Network (LAN) at the healthcare provider's location. The computer used can be an inexpensive Personal Computer (PC) or Networked Computer (NC) that is able to run the EZ-R Module application. The Kiosk is equipped with a touch sensitive screen 40 and a keyboard 45 for the patient to fill out the UM-GUI forms. The UM-GUI forms (FIGS. 6, 6a-6k, 7) will be shown on the touch-sensitive screen 40 and the patient will touch the screen to enter the information and to navigate the forms. By making use of a touch-sensitive screen, the Kiosk obviates the need for the patient to know how to use a computer pointing device like a mouse or trackball. The Kiosk is further equipped with speakers 41 to give spoken instructions in multiple languages to guide the patient in filling out the forms. The EZ-R Kiosk will make use of biometrics identification technologies to record and to subsequently verify the patient's identity. The Kiosk can incorporate a variety of biometrics identification devices available on the market. These include a fingerprint scanner 42, a palm scanner (not shown), a microphone for voice recognition 43, and a camera for face or retina recognition, and for photo identification 44. The EZ-R Kiosk would incorporate one or more of these devices to verify the identity of the patient, eliminating the potential for fraud. To record the patient's signature electronically, an electronic pen 46 and electronic signature pad 46a is used. For those patients that require additional help in filing out the forms, the camera, microphone and speakers can be also used to provide one- or two-way video conferencing capabilities with an administrator. Referring to FIG. 9, the Kiosks can be provided with privacy screens 48 to ensure the confidentiality of the patient's information.

After the initial registration, the patient is issued a personalized EZ-MD Card from the Kiosk. The EZ-MD Card makes use of widely-available Smart Cards which are commonly credit card-sized cards with a small built-in microchip for storing information. The Kiosk is equipped with a Smart Card reader/writer (FIG. 8, 47) to read and write information onto the Smart Card. The Smart Card terminal application/applet consists of two separate components. One component is dedicated to new card generation to each specific patient. The process of card generation involves writing patient registration data on the card for future access. The second component is designed to allow reading and eventual updating of patient information stored on the card.

With his personal EZ-MD card, the patient can use it on subsequent visits to the healthcare provider or on visits to a new provider in the MD Net Exchange Network. Referring to FIG. 10, a patient can use his personal EZ-MD card 50 to check-in quickly and easily by simply swiping the card in the EZ-MD card slot in the Kiosk 51. The Kiosk will then verify his identity by one or more the above-discussed biometric identification devices 52. Once the patient's identity is verified, an administrators or nurses' station will be notified that the patient has checked in 53, and to place the patient in a queue waiting for service from the doctor or pharmacist. If the patient's identity cannot be verified, the administrator's station will be alerted 54 for the administrator to investigate possible unauthorized access, or to otherwise assist the patient in the verification process. The patient is then able to access his personal information if desired 55 and to make any necessary changes, which will be updated in the PMIS 56. A patient can also review his medical history if needed, and the medical history file will be retrieved from the PMIS 57. His physician can also access the medical history 58 from a terminal in the doctor's office or examination room, and input his diagnosis after examining the patient 59. This information will be uploaded to the PMIS server 60 and integrated with the patient's medical history file 61.

The Physician Examination Module (“PEM”), another module in the MD Net Exchange system, assists the physician in his examination, diagnosis and preparation of the medical report on the patient. The PEM can run on a kiosk placed in the examination room, similar to the EZ-R Kiosk disclosed above, or on a personal computer connected to the network. The PEM Kiosk can incorporate many of the features of the EZ-R Kiosk, including having a touch-sensitive screen, in order to speed up data entry for the doctor. In addition, the PEM Kiosk can incorporate various standard diagnosis tools such as a blood pressure gauge and digital thermometer, and the Kiosk can directly display the readings and record them into the PEM module.

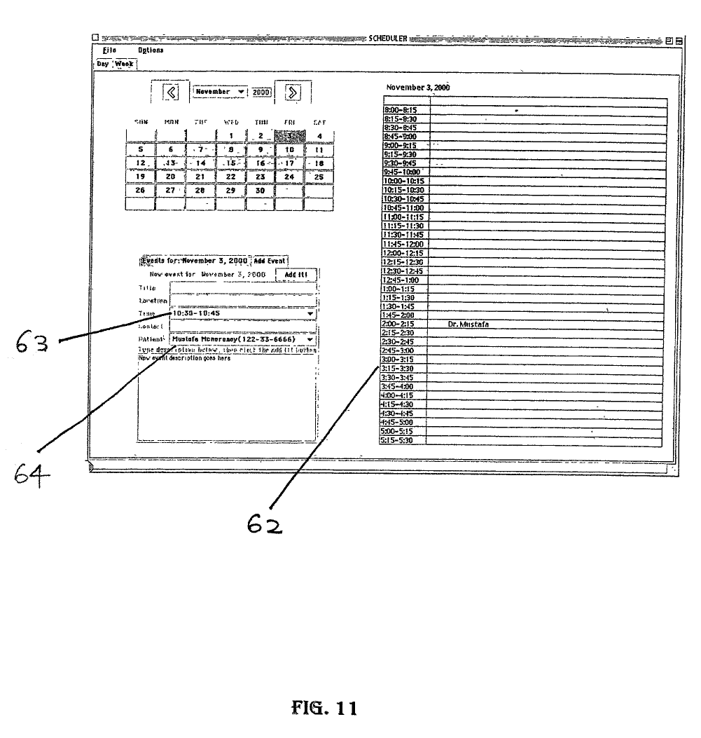

Referring to FIG. 11, the PEM module will incorporate scheduling capacities 62, 63 for the physician or physician's aide. He can easily schedule patients using, for example, a pull down list of his patients that was complied from the EZ-R module 64.

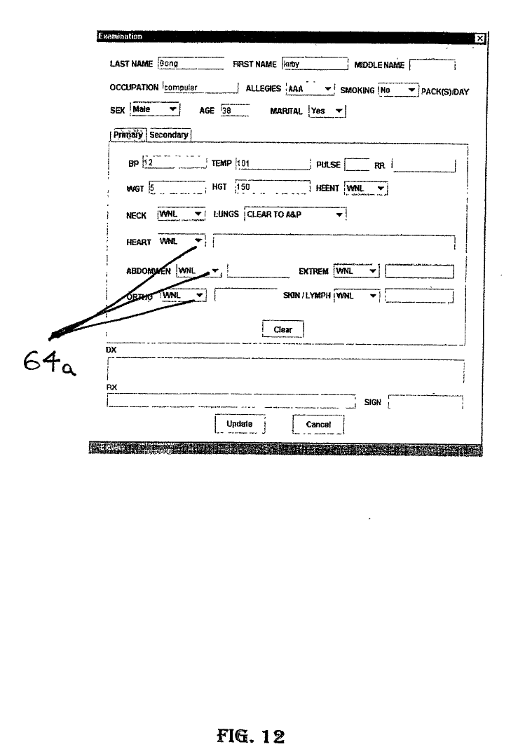

Referring to FIG. 12, the PEM module will assist the physician in preparing his report, both during and at the conclusion of his examination of the patient. Extensive use of pull down menus 64a will simplify and expedite filling out the examination report. Data fields will be standardized so that crucial information about the patient will not go unrecorded. The module can also incorporate voice recording and voice recognition routines for the physician to dictate or annotate his report.

As the PEM is linked to the PMIS database, the prior medical history (including medical reports and test results) of the patient is available for reference by the physician, and can be displayed in multi-media formats. Once completed, the new report is recorded in the PMIS instantaneously.

The Electronic Prescription Module (“EPM”) is another module in the MD Net Exchange system, and is tightly integrated with the PEM module. Electronic Prescription allows a physician to select and submit prescriptions electronically, eliminating potentially life-threatening errors due to illegible hand-writing. Further, the EPM incorporates decision-support features in assisting the physician and to minimize the opportunity for errors. It includes an Electronic Prescription Drug Reference Library (“EPDRL”) component which is integrated with the Electronic Prescription writing component for quick reference by the physician. The drugs will be cross-referenced, and will alert the physician to any drug interaction side-effects. Potential problems arising from incorrect dosage or mis-prescribed drugs because of similar drug names, can be easily caught by the physician writing the prescription, and not just the pharmacist. Finally, the EPM can cross-reference the PEM to ensure the physician has prescribed the correct treatment for the diagnosis as recorded in his medical report.

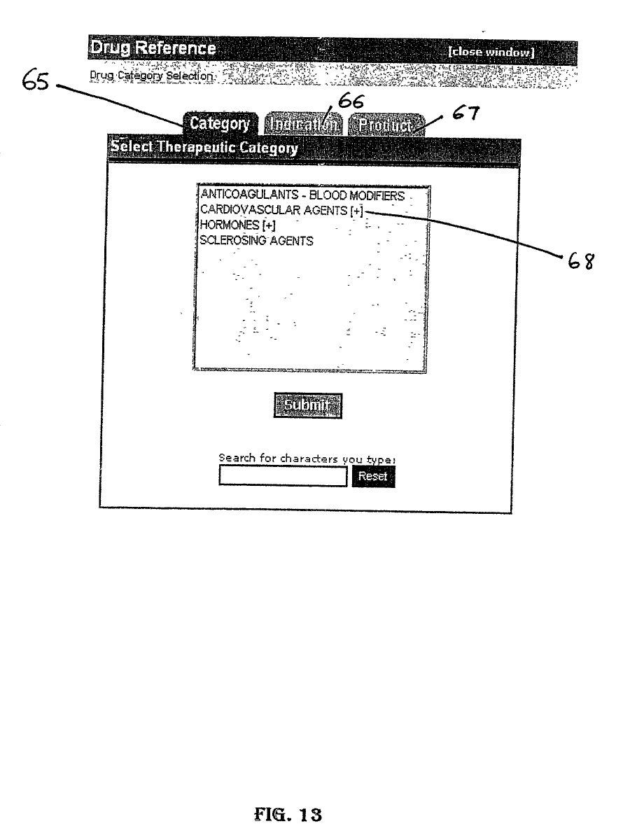

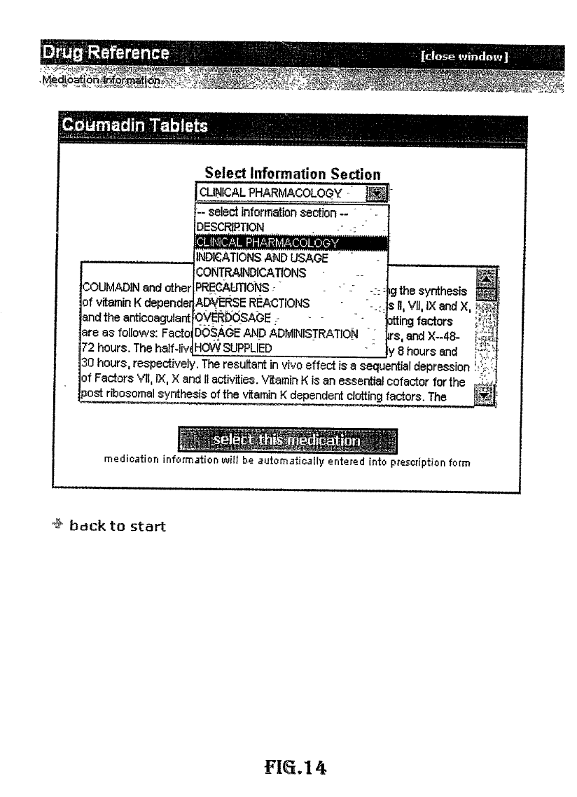

Referring to the embodiment depicted in FIG. 13, the physician begins writing an electronic prescription by selecting either a category of drugs 65, the patient's indication 66, or the pharmaceutical product by name 67. The selections available are shown in a branching structure 68 that has further selections. Referring to the embodiment depicted in FIG. 14, the EPDRL can allow the physician to quickly look up and verify information available on a selected drug. Once the physician has decided on a prescription, it can be finalized with just hitting the submit button.

After writing the prescription electronically, the physician can i) upload it to the PMIS server, where it can be accessed by a pharmacy on the MD Net Exchange system; ii) upload it directly to a pharmacist in the network; or iii) print out a hard copy for the patient if the patient's pharmacist is not on the MD Net Exchange system. By Utilizing the above-discussed EZ-MD card bio-metric identification methods with methods i) and ii), it can be ensured that the drugs go to the intended recipient.

Although the present invention and its advantages have been described in the foregoing detailed description and illustrated in the accompanying drawings, its will be understood by those skilled in the art that the invention is not limited to the embodiment(s) disclosed but is capable of numerous rearrangements, substitutions and modifications without departing from the spirit and scope of the invention as defined by the appended claims.

What is claimed is:

1. A system for the integrated management of healthcare information comprising:
a patient information database which resides on a computer connected to a network and is adaptable to holding personal information, medical records, clinical test information, diagnosis information, scheduling information, insurance information, and prescription information of patients; and
a plurality of application modules that can access, update and share information in the patient information database.

2. The system of claim 1 wherein the personal information, medical records, clinical test information, diagnosis information, scheduling information, insurance information, and prescription information is stored in the patient information database in multi-media formats.

3. The system of claim 1 wherein the application modules reside on a computer connected to a network that can remotely access the patient information database.

4. The system of claim 1 wherein the application modules reside on the same computer as the patient information database.

5. The system of claim 1 wherein one application module is a patient registration module.

6. The system of claim 1 wherein one application module is an electronic prescription module.

7. The system of claim 1 wherein one application module is a patient information database administration module.

8. The system of claim 1 wherein one application module is an insurance claim module.

9. The system of claim 1 wherein one application module is a physician examination module.

10. The system of claim 5 wherein the patient registration module includes means to interactively guide the patient to input information.

11. The system of claim 10 wherein the means to interactively guide the patient to input information is a touch-sensitive screen on a computer monitor.

12. The system of claim 10 wherein the means to interactively guide the patient to input information is spoken verbal information.

13. The system of claim 10 wherein the means to interactively guide the patient to input information is video information.

14. The system of claim 5 wherein the patient registration module includes means to verify a patient's identity.

15. The system of claims 10, 11, 12 or 13 wherein the means to interactively guide the patient to input information is incorporated into an electronic kiosk connected to a network that can access the patient information database.

16. The system of claim 14 wherein the means to verify the patient's identity is incorporated into an electronic kiosk connected to a network that can access the patient information database.

17. The system in claim 14 wherein the means to verify a patient's identity includes use of a smart card and a smart card reader/writer.

18. The system in claim 16 wherein the smart card is adaptable to carry a patient's personal, medical and insurance information.

19. The system in claim 18 wherein a patient's personal, medical and insurance information carried on the smart card is accessible by emergency medical workers, physicians and administrators.

20. The system in claim 14 wherein the means to verify a patient's identity includes biometric means.

19. The system of claims 15 or 16 wherein the electronic kiosk has video conferencing capabilities.

20. The system of claims 15 or 16 wherein the electronic kiosk includes an electronic pen for capturing the patient's writing.

21. The system of claim 6 wherein the electronic prescription module includes physician decision support functions.

22. The system of claim 21 wherein the physician decision support functions include an electronic prescription drug reference library.

23. The system of claim 9 wherein the physician examination module includes scheduling capabilities.

24. The system of claim 9 wherein the physician examination module includes physician decision support functions.

25. The system of claim 24 wherein the physician decision support functions include an electronic medical reference library.

26. The system of claim 24 wherein the physician decision support functions include error correcting capabilities.

27. The system of claim 9 wherein the physician examination module is incorporated into an electronic kiosk connected to a network that can access the patient information database.

28. The system of claim 27 wherein the electronic kiosk includes patient diagnostic tools.

29. The system of claims 5, 6, 7, 8 or 9 wherein the application module uses a standardized graphical user interface.

30. The system of claim 29 wherein the standardized graphical user interface can be accessed by an Internet browser program.

31. The system of claim 29 wherein the standardized graphical user interface is a Java applet.
